(19) United States
(12) Patent Application Publication
(10) Pub. No.: US 2023/0100924 A1
(43) Pub. Date: Mar. 30, 2023

(54) SKILL OUTPUT DEVICE, SKILL OUTPUT METHOD, AND SKILL OUTPUT PROGRAM

(71) Applicant: NEC Corporation, Minato-ku, Tokyo (JP)

(72) Inventors: Hiroshi TAMANO, Tokyo (JP); Toshiyuki KATAOKA, Tokyo (JP)

(73) Assignee: NEC Corporation, Minato-ku, Tokyo (JP)

(21) Appl. No.: 17/801,876

(22) PCT Filed: Mar. 24, 2020
(86) PCT No.: PCT/JP2020/013031

§ 371 Date: Aug. 24, 2022

(51) Int. Cl. G09B 7/04; G06Q 50/20

(52) U.S. Cl. CPC G09B 7/04; G06Q 50/20

(57) ABSTRACT

The output means 81 outputs a threshold value indicating a proficiency level of a skill required to answer a target question in association with the proficiency level of the skill that the learner is assumed to have.

### TECHNICAL FIELD

This invention relates to a skill output device, a skill output method, and a skill output program for outputting the state of learner's skills.

### BACKGROUND ART

In order to make education more effective, it is important to provide education that is tailored to individual learners. Such a system is called adaptive learning. To realize such a mechanism, computers are required to automatically provide skills tailored to each individual learner. Specifically, it is necessary to constantly trace the state of knowledge of each learner and provide appropriate learning according to that state of knowledge. This technology for tracing the state of each learner's knowledge and providing appropriate information is also known as knowledge tracing.

Knowledge Trace visualizes the skills of learners to grasp their learning state in real time, predicts whether or not they will be able to answer questions, and provides optimal questions tailored to them. For example, Patent Literature 1 describes a test creation server that supports effective review by closely grasping the student's own proficiency level for each study content, and also creates a collection of exercise questions optimized for the student's own proficiency level for each study content, etc.

In addition, Non-Patent Literature 1 describes an interpretable knowledge tracing with a probabilistic model based on non-compensatory item response model.

### CITATION LIST

### Patent Literature

Patent Literature 1: Japanese Patent Application Laid-Open No. 2012-93691

### Non Patent Literature

Non-Patent Literature 1: Hiroshi Tamano, Daichi Mochihashi, “Non-Compensatory Temporal IRT with Local Variational Approximation,” Shin Gaku Giho, vol. 119, no. 360, IBISML2019-31, pp. 91-98, January 2020.

### SUMMARY OF INVENTION

### Technical Problem

As in the test creation server described in Patent Literature 1, generally, Artificial Intelligence (AI) judges the learner's skills and provides appropriate questions. At first glance, such a learning method in which the learner unilaterally answers the questions provided by the AI may be considered efficient. However, while the learner's ability to answer the questions may improve, the learner may not acquire the ability to think independently about how to deal with his or her own weaknesses.

Therefore, it is preferable to be able to provide a learning method that allows users to decide for themselves what to study while interacting with the AI, that is, a learning method that allows the learner to use the AI in a proactive manner. For that purpose, it is necessary to provide feedback of information that enables learners to think independently about how to respond to their own weaknesses with the AI.

For example, the test creation server described in Patent Literature 1 displays a learning achievement rate in three levels: ∘ (circle indicating all correct answers), Δ (triangle indicating some incorrect answers), and × (cross indicating all incorrect answers), according to the ratio of the number of correct answers to the number of questions asked in a small unit. However, since the content of the display described in Patent Literature 1 only shows the results of correct or incorrect answers, it is not possible to grasp the degree to which the user has fulfilled the skills required to answer the questions.

Therefore, it is an exemplary object of the present invention to provide a skill output device, a skill output method, and a skill output program that can represent the satisfaction state of the learner's skills required to answer questions.

### Solution to Problem

A skill output device according to the present invention includes an output means which outputs a threshold value indicating a proficiency level of a skill required to answer a target question in association with the proficiency level of the skill that the learner is assumed to have.

A skill output method according to the present invention includes outputting a threshold value indicating a proficiency level of a skill required to answer a target question in association with the proficiency level of the skill that the learner is assumed to have.

A skill output program according to the present invention causes a computer to execute: output process of outputting a threshold value indicating a proficiency level of a skill required to answer a target question in association with the proficiency level of the skill that the learner is assumed to have.

### Advantageous Effects of Invention

According to the invention, it can represent the satisfaction state of the learner's skills required to answer questions.

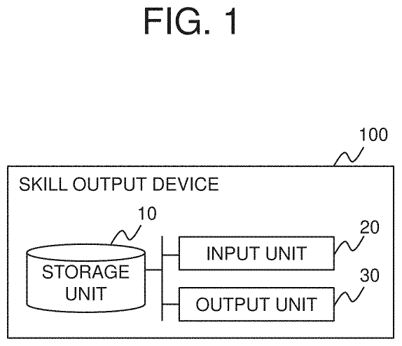

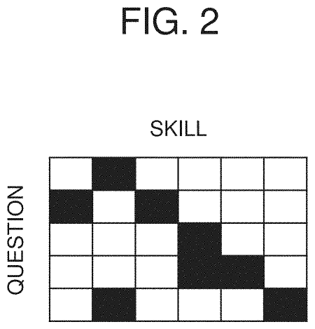

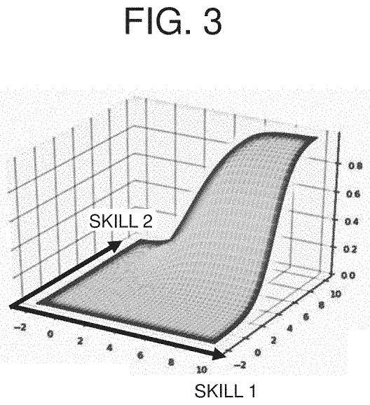

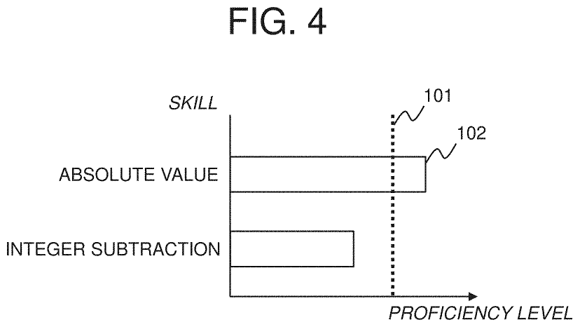

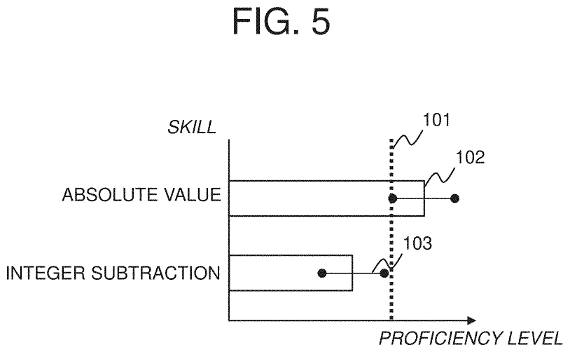

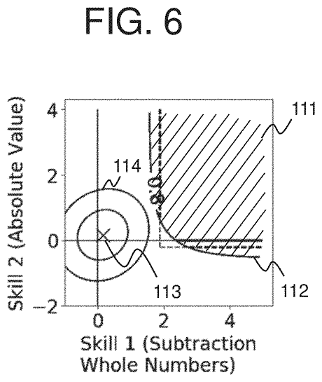

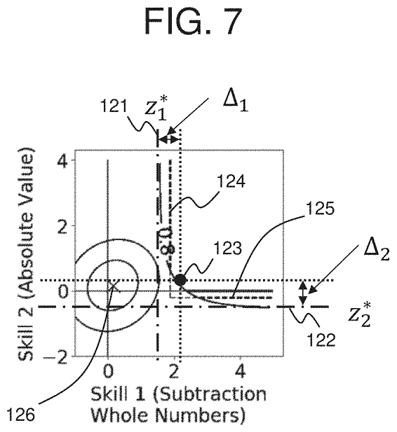

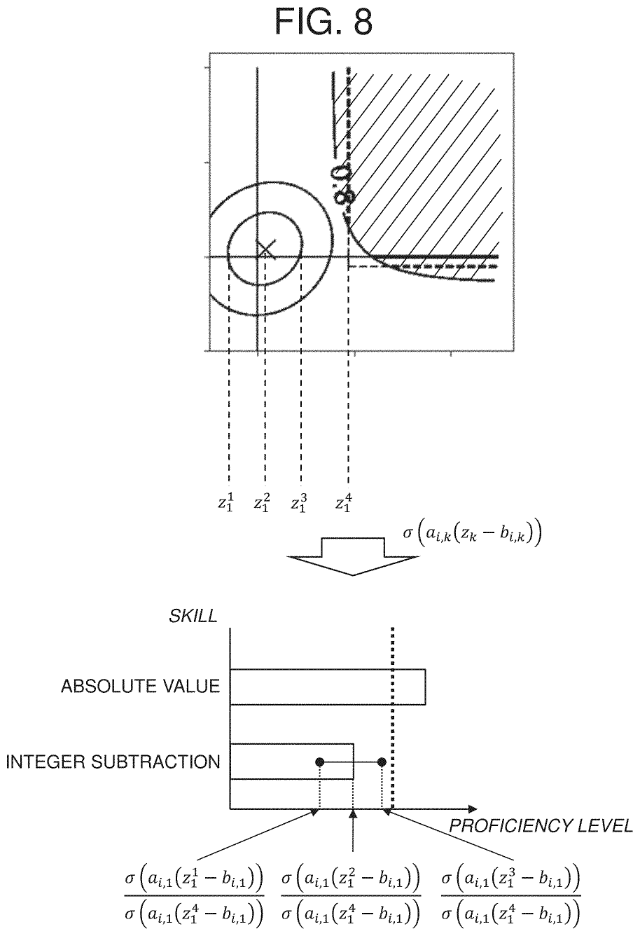

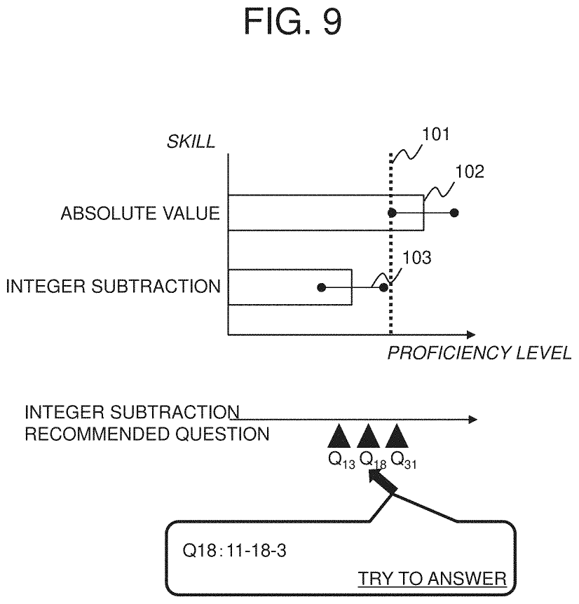

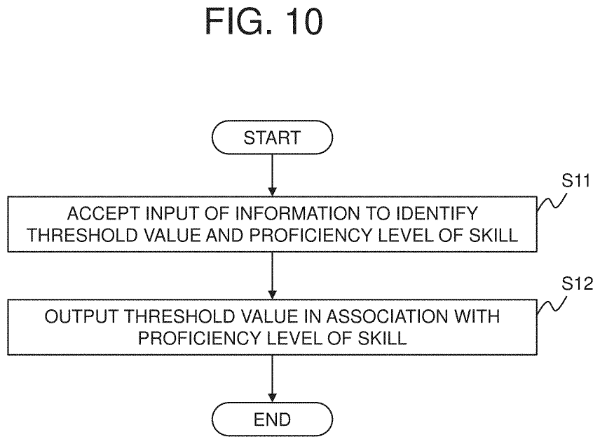

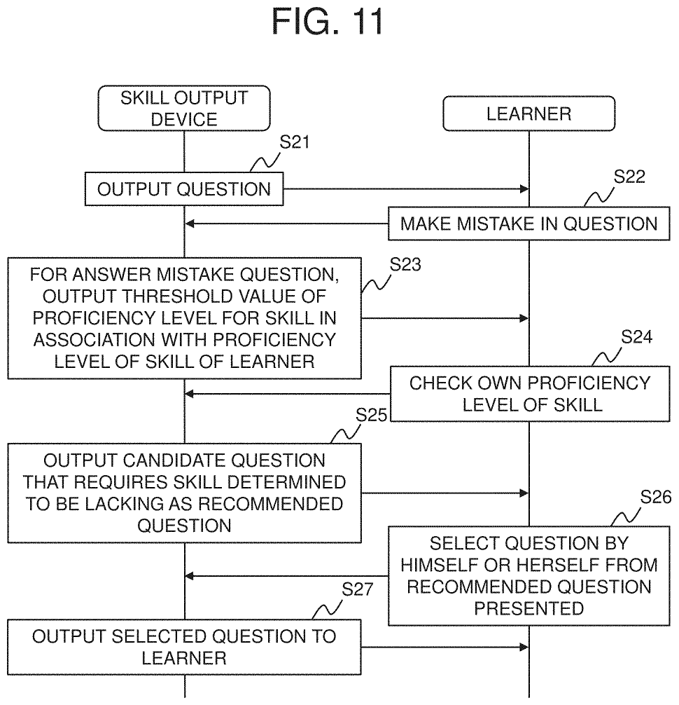

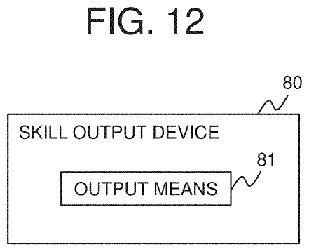

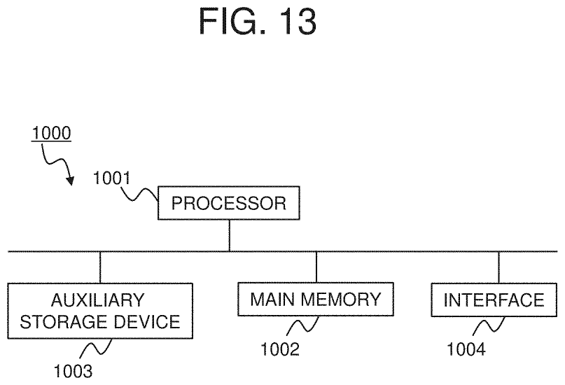

### BRIEF DESCRIPTION OF DRAWINGS

[FIG. 1] It depicts a block diagram showing a configuration example of one exemplary embodiment of a skill output device according to the present invention.

[FIG. 2] It depicts an explanatory diagram showing an example of associating a question with a required skill.

[FIG. 3] It depicts an explanatory diagram showing an example of a likelihood function for a correct answer probability.

[FIG. 4] It depicts an explanatory diagram showing an example of a skill sufficiency output as a graph.

[FIG. 5] It depicts an explanatory diagram showing another example of a skill sufficiency output as a graph.

[FIG. 6] It depicts an explanatory diagram showing schematically representing information of a non-compensatory model.

[FIG. 7] It depicts an explanatory diagram showing an example of a process of calculating a threshold value.

[FIG. 8] It depicts an explanatory diagram showing an example of a process of visualizing results.

[FIG. 9] It depicts an explanatory diagram showing an example of an output of a recommended question.

[FIG. 10] It depicts a flowchart showing an operation example of the skill output device.

[FIG. 11] It depicts an explanatory diagram showing a specific example of a learning method using the skill output device.

[FIG. 12] It depicts a block diagram showing an overview of the skill output device according to the present invention.

[FIG. 13] It depicts a schematic block diagram showing a configuration of a computer for at least one example embodiment.

### DESCRIPTION OF EMBODIMENTS

Hereinafter, exemplary embodiments of the present invention will be described with reference to the drawings.

FIG. 1 is a block diagram showing a configuration example of one exemplary embodiment of a skill output device according to the present invention. The skill output device 100 of this exemplary embodiment includes a storage unit 10, an input unit 20, and an output unit 30.

The storage unit 10 stores various information used by the skill output device 100 of this exemplary embodiment for processing. Specifically, the storage unit 10 stores skills required to answer each question. FIG. 2 is an explanatory diagram showing an example of associating a question with a required skill. In the example shown in FIG. 2, an example in which a question and a skill required to answer the question is associated in a tabular format is shown. As illustrated in FIG. 2, there may be one, two or more skills required for each question. The association between questions and required skills is set in advance by a user or others.

In addition, the storage unit 10 stores information for identifying a value indicating a proficiency level of the skill required to answer the target question (hereinafter referred to as a threshold value). The threshold value can be referred to as the difficulty level of the question. The storage unit 10 may store the threshold value itself, which is set individually for each of the skills required to answer each question. The storage unit 10 may also store a probability model that represents distribution of correct answer probability according to the proficiency level of the skills that the learner has, which is a model learned based on the learner's past learning experience. When such a probability model is stored, it is possible to specify the threshold value by setting the correct answer probability to an arbitrary value (e.g., 80%). Furthermore, the storage unit 10 may store proficiency level of the skill in the learner.

In the following, it is explained how to identify the threshold value using the probabilistic model, taking as an example the non-compensatory item response model described in Non-Patent Literature 1. When skills are associated with a certain question, it is common to assume that the question can be answered by satisfying all of those skills. Such a model described in Non-Patent Literature 1 is called a non-compensatory model in multidimensional item response theory. The explanation of the reason for the prediction using this non-compensatory model is natural.

The following is an explanation of the non-compensatory model using specific examples. Here, it is assumed a prediction model that indicates whether or not a question concerning equations involving fractions (e.g., x/5+3/10=2x) can be answered. To answer this question, it is assumed that fractional skill s₁ and equation skill s₂ are required.

In the non-compensatory model, the model predicting the correct answer probability is represented by the product of each skill. For example, if the coefficients of each skill s₁, and s₂ are t₁, and t₂ respectively, the predictive model can be expressed using the sigmoid function σ as follows. Such a non-compensatory model is highly explanatory because it is interpreted as “the above question cannot be answered without knowledge of fractions and equations”.

Correct answer probability=σ(t₁s₁)σ(t₂s₂)

The model that represents the probability that a learner can answer a question i given the learner's state z and question i can be defined, for example, by Equation 1 illustrated below. That is, the model illustrated in Equation 1 is a model that is represented by a combination of the skills k required by the learner to answer the question i, and the probability of answering the question is calculated by the product of each skill. The learner's state z represents the proficiency level of each skill k that the learner has at a given point in time.

$$\begin{matrix}[ Math . 1 ] & \\ p ( {a}_{i} , {b}_{i} , z ) = {\prod }_{k} σ ( {a}_{i , k} ( {z}_{k} - {b}_{i , k} ) ) & ( Equation 1 )\end{matrix}$$

In Equation 1, b_{i,k} represents the degree of difficulty of skill k used in question i, and a_{i,k} is a parameter that represents the degree of rise (slope) of skill k with respect to question i. That is, Equation 1 represents that a question can be answered with a higher probability when the skill proficiency zₖ is higher than the degree of difficulty indicated by b_{i,k}.

FIG. 3 is an explanatory diagram showing an example of a likelihood function for a correct answer probability. In the graph illustrated in FIG. 3, the vertical axis (z-axis) represents the correct answer probability, and the other axes (x-axis and y-axis) represent the proficiency level of the skill required to answer the question. Specifically, the likelihood function illustrated in FIG. 3 is represented by Equation 1 illustrated above. For example, it is assumed that two skills are required to answer a certain question, as illustrated in FIG. 3. In this case, the correct answer probability does not increase when only one skill is higher than the other, but the correct answer probability increases when both skills are higher than the other.

For example, in the example shown in FIG. 3, it is assumed that in order to answer the question, the administrator assumes that the proficiency level of the skill is required such that the correct answer probability=80%. In this case, the cross-section when cut perpendicular to the axis of correct answer probability, which is the value of the likelihood function, at the position of correct answer probability=0.8, can be said to represent the range of the skill proficiency.

By using such a model, it is possible to identify the threshold value. The method of identifying the threshold value using this model is described below. However, the model used to identify the threshold value is not limited to the non-compensatory model described above, but can be any model that can identify the skill required to answer each question.

The storage unit 10 may also store the target question itself (e.g., question sentences diagrams, etc.). The storage unit 10 is realized by a magnetic disk or the like.

The input unit 20 accepts input of information to identify the proficiency level of the skill that the learner is assumed to have. The input unit 20 may acquire the proficiency level of the skill in the target learner from the storage unit 10. The input unit 20 may also accept an input of the uncertainty of the skill that the learner has. In the case where the state representing the learner's skill follows a Gaussian distribution, the uncertainty of the skill that the learner has may be calculated by the output unit 30 as described below.

The input unit 20 also accepts input of information to identify a threshold value that indicates the proficiency level of the skill required to answer the target question. The input unit 20 may acquire the threshold value from the storage unit 10, or may acquire information about the model used to calculate the threshold value.

The output unit 30 outputs a learner's skill sufficiency required to answer the question. Specifically, the output unit 30 outputs the proficiency level of a skill (i.e., threshold value) required to answer the target question in association with the proficiency level of the skill that the learner is assumed to have. When a plurality of skills are required to answer the question, the output unit 30 outputs the threshold values for each of the plurality of skills required to answer the target question in association with each of the proficiency level of the plurality of skills that the learner is assumed to have.

The method by which the output unit 30 outputs the skill sufficiency is arbitrary. For example, the output unit 30 may output the skill sufficiency in a graph format, or output the skill sufficiency as text. FIG. 4 is an explanatory diagram showing an example of a skill sufficiency output as a graph. In the example shown in FIG. 4, the dotted line 101 represents the threshold value and the bar graph 102 represents the proficiency level of the skill. The threshold value is, for example, “a proficiency level that satisfies 80% correct answer probability”.

In the example shown in FIG. 4, the threshold value is output at the same proficiency level position for all skills, but the position of the threshold value may be different from each other. The graph format is not limited to a bar graph as illustrated in FIG. 4, but may be a line graph or radar chart. In this way, the output unit 30 outputs the threshold values in association with the proficiency level of the skill that the learner is assumed to have, thereby the skill sufficiency of the learner required to answer the question. Thus, the learner can grasp the degree to which he or she has the skills required to answer the question.

In addition, the output unit 30 may output the proficiency level of the skill that the learner is assumed to have, together with the uncertainty of the proficiency level. The output unit 30 may output the uncertainty received by the input unit 20, or output the calculation results based on the uncertainty of the learner's state. The method of calculating the learner's uncertainty is described below.

FIG. 5 is an explanatory diagram showing another example of a skill sufficiency output as a graph. In the example shown in FIG. 5, the uncertainty representing the variable skill status is indicated by a line 103, and the line 103 is superimposed on the bar graph 102. The output unit 30 may output the proficiency level of the skill and uncertainty together in this manner.

The output unit 30 may use a model representing distribution of a correct answer probability for each question according to the proficiency level of the learner's skill to output the threshold value for each skill calculated by the specified correct answer probability and the proficiency level of the learner's skill relative to the threshold value. The following is an example of the output method when using the non-compensatory model described above. FIG. 6 is an explanatory diagram showing schematically representing information of the non-compensatory model. The information illustrated in FIG. 6, for example, is information for handling the non-compensatory model inside the analysis engine, and indicates that two skills (“integer subtraction” and “absolute value”) are required for the target question. In this case, it is also assumed that the proficiency level of the skill is specified as being required to have a correct answer probability=80%.

The shaded area 111 in the upper right corner of the graph shows the range of skill proficiency levels that satisfy the correct answer probability=80% in the likelihood function illustrated in FIG. 3. The curve 112, which is described as 0.8, represents the boundary of the proficiency level of the skill required to satisfy the correct answer probability=80%. The x mark 113 shown in the lower left corner of the graph represents the state of the learner's skill at this point in time. The ellipse 114 surrounding the x mark 113 is the contour line of the probability in the case that the distribution of the learner's skill status follows a Gaussian distribution. The ellipse 114 indicates the contour line of probability when the distribution of the learner's skill state follows a Gaussian distribution. In this case, the position of the learner's skill state corresponds to the mean in the Gaussian distribution.

Based on this assumption, the output unit 30 calculates the threshold value. The threshold value calculated here corresponds to the threshold value indicated by the dotted line 101 illustrated in FIG. 4. FIG. 7 is an explanatory diagram showing an example of a process of calculating a threshold value. First, the output unit 30 calculates the coordinates zₖ* for each dimension. For example, the output unit 30 calculates zₖ* using Equation 2 shown in the example below, based on Equation 1 above.

$$\begin{matrix}[ Math . 2 ] & \\ {z}_{k}^{*} = \frac{{σ}^{- 1} ( p )}{{a}_{i}} + {b}_{i} & ( Equation 2 )\end{matrix}$$

Note that p in Equation 2 indicates the correct answer probability, and aᵢ and bᵢ indicate slope and difficulty, respectively, as in Equation 1. The zₖ* calculated here corresponds to the coordinates of a surface tangent to the likelihood function illustrated in FIG. 3 from the outside, and corresponds to the long chain lines 121 and 122 in FIG. 7.

Next, the output unit 30, while varying the coordinates on the boundary, searches for the coordinate z\hat{ } (superscript hat of z) that comes closest to Δ₁=Δ₂= . . . =Δ_{K} (where K is the number of skills required) while changing the coordinates on the boundary. Note that Δ is difference between zₖ* and z\hat{ } calculated for each dimension. The z\hat{ } calculated here corresponds to the coordinates of a surface tangent to the likelihood function illustrated in FIG. 3 from the inside, corresponding to the coordinates of point 123 in FIG. 7.

Specifically, the output unit 30 repeats the following two processes in calculating the coordinates z\hat{ }. As the first process, the output unit 30 calculates

$$\begin{matrix}[ Math . 3 ] & \\ {z}_{k} = \frac{{σ}^{- 1} ( {p}^{\frac{1}{k}} )}{{a}_{i}} + {b}_{i} & \end{matrix}$$

as an initial point. The output unit 30 then calculates the value of each Δₖ based on this zₖ. Next, as a second process, the output unit 30 performs update shown in Equation 3 below for dimension k for the largest Δₖ. Note that δ is a parameter and is predetermined.

zₖₘₐₓ←zₖₘₐₓ−δ (Equation 3)

The output unit 30 sets the updated zₖₘₐₓ to z′ and performs update shown in Equation 4 below for the dimension k for the smallest Δₖ. The output unit 30 repeats these two processes until the predetermined conditions (e.g., the amount of change is less than a threshold value, predetermined number of times, etc.) are met.

$$\begin{matrix}[ Math . 4 ] & \\ scale = p ( {a}_{i} , {b}_{i} , {z}^{′} ) / p ( {a}_{i} , {b}_{i} , z ) \\ {p}_{kmin} = \frac{σ ( {a}_{i} ( {z}_{kmin} - {b}_{kmin} ) )}{scale} \\ {z}_{kmin} ← \frac{{σ}^{- 1} ( {p}_{kmin} )}{{a}_{i}} + {b}_{i} & ( Equation 4 )\end{matrix}$$

Next, the output unit 30 approximates the region rectangularly by calculating (z\hat{ }ₖ−zₖ*)/2 for each k. The values calculated here correspond to the coordinates of the dashed lines 124 and 125 in FIG. 7.

The output unit 30 then outputs a bar graph based on the ratio between the learner's proficiency level of the skill and the value indicated by the rectangular approximated coordinates. Specifically, the output unit 30 may output a bar graph based on the ratio of the coordinates 126 indicating the learner's skill status and the coordinates indicated by the dashed lines 124 and 125. In addition, the output unit 30 may output the uncertainty of the learner's skill status together with the uncertainty of the learner's skill status.

FIG. 8 is an explanatory diagram showing an example of a process of visualizing results. For example, it is assumed that the learner's skill state for skill 1 (integer subtraction) is estimated as z₁² and the variance ±σ of the skill state in the Gaussian distribution is z₁¹ and z₁³, respectively. Then, it is assumed that the coordinates of the dashed line 124 in FIG. 7 are calculated to be z₁⁴. In this case, the output unit 30 calculates the proficiency level of the learner's skill 1 as σ (a_{i,1} (z₁²−b_{i,1}))/σ (a_{i,1} (z₁⁴−b_{i,1})).

The output unit 30 may also output the variance of the Gaussian distribution as the uncertainty of the proficiency level, using the distribution indicating the state of the learner's skill estimated by the Gaussian distribution. Specifically, the output unit 30 calculates the range of the uncertainty as σ (a_{i,1} (z₁¹−b_{i,1}))/σ (a_{i,1} (z₁⁴−b_{i,1})) and σ (a_{i,1} (z₁³−b_{i,1}))/σ (a_{i,1} (z₁⁴−b_{i,1})). The same is true for skill 2 (absolute value).

Thus, the output unit 30 calculates the proficiency level of the relative skill and uncertainty when the threshold value is set to 1. In other words, the output unit 30 expresses the current proficiency level and uncertainty of the learner's skills relative to the threshold value, associated with the skill name. Thus, the learner's skill over/under can be presented based on skill names that are understandable to the learner. Furthermore, the output unit 30 expresses the uncertainty of each skill together, thereby improving the learner's sense of conviction.

In addition, the output unit 30 may identify skills for which the proficiency level does not satisfy the threshold (sometimes hereafter referred to as “causal skill”) and output a candidate question that require the identified skill as “recommended question”. Specifically, the output unit 30 may identify the candidate question for a question that requires the causal skill from a table in which the question as illustrated in FIG. 2 and the skill required to answer the question are associated with each other. In addition, the output unit 30 may output as candidates not only questions that require only the causal skill, but also questions that require the same combination of skills as the question in which the mistake was made.

Furthermore, the output unit 30 may output only questions with a predetermined range of difficulty among the identified candidate questions. For example, the output unit 30 may output as candidates the questions of difficulty corresponding to z₁¹ to z₁⁴ illustrated in FIG. 8. As an application of this, the output unit 30 may output a predetermined number of questions with difficulty levels before or after the predetermined range in addition to the questions with difficulty levels in the predetermined range (e.g., z₁² to z₁⁴).

For example, when the storage unit 10 directly stores the difficulty level of each question based on skill, the output unit 30 may output the candidate questions based on that difficulty level. When the storage unit 10 stores a non-compensatory model as described above, the difficulty corresponds to bᵢ, then the output unit 30 may output the candidate questions based on the bᵢ.

FIG. 9 is an explanatory diagram showing an example of an output of a recommended question. The example shown in FIG. 9 indicates that the output unit 30 identifies a lack of skill in “integer subtraction” and outputs candidate questions (recommended questions: Q₁₃, Q₁₈, Q₃₁) that require the identified skill, ordered according to the degree to which the skill is required (i.e., proficiency level, difficulty). As illustrated in FIG. 9, when a learner mouses over a number of recommended questions with a pointing device such as a mouse, the output unit 30 may output the questions corresponding to that number.

The input unit 20, and the output unit 30 are provided by a computer processor (for example, CPU (Central Processing Unit), GPU (Graphics Processing Unit) operating according to the program (skill output program).

For example, a program may be stored in the storage unit 10, and the processor may read the program and, according to the program, operate the input unit 20, and the output unit 30. In addition, the functions of the appearance inspection device 20 may be provided in SaaS (Software as a Service) format.

The input unit 20, and the output unit 30 may each be realized by dedicated hardware. In addition, some or all of the components of each device may be realized by a general-purpose circuit (circuitry) or a dedicated circuit, a processor, etc., or a combination of these. They may be configured by a single chip or by multiple chips connected via a bus. Some or all of the components of each device may be realized by a combination of the above-mentioned circuits, etc. and programs.

In the case where some or all of the components of the input unit 20 and the output unit 30 are realized by a plurality of information processing devices, circuits, or the like, the plurality of information processing devices, circuits, or the like may be centrally located or distributed. For example, the information processing devices, circuits, etc. may be realized as an embodiment where each of which is connected via a communication network, such as a client-server system, a cloud computing system, etc.

Next, the operation of this exemplary embodiment of the skill output device 100 will be described. FIG. 10 is a flowchart showing an operation example of the skill output device 100 of this exemplary embodiment. The input unit 20 accepts input of information to identify the threshold value and the proficiency level of the skill (step S11). The output unit 30 outputs the identified threshold value in association with the proficiency level of the skill (step S12).

Next, specific examples of learning methods using the skill output device 100 will be described. FIG. 11 is an explanatory diagram showing a specific example of a learning method using the skill output device 100. First, the skill output device 100 (output unit 30) outputs a question to the learner (step S21). The learner answers the output question. Now, it is assumed that the learner makes a mistake in the question (step S22). Here, the skill output device 100 outputs, for the answer mistake question, the threshold values of the proficiency level for the skills in association with the proficiency level of the skill of the learner (step S23). The learner checks own proficiency level of the skill (step S24). The skill output device 100 also outputs candidate questions that require the skills determined to be lacking as recommended questions (step S25). After confirming the skills that are lacking, the learner selects a question that he or she judges to be necessary from among the recommended questions presented (step S26). The output unit 30 outputs the selected questions to the learner (step S27). Thereafter, the process from step S22 onward is repeated.

By presenting such a learning method to learners, it is believed that the learners will be able to think independently about how to deal with their own weaknesses.

As described above, in this exemplary embodiment, the output unit 30 outputs the threshold value indicating the proficiency level of the skill required to answer a target question in association with the proficiency level of the skill that the learner is assumed to have. Thus, it can represent the satisfaction state of the learner's skills required to answer questions.

For example, in a general knowledge tracing system, when there are multiple skills required to answer a single question, it is difficult to quantify and clearly indicate which skill is lacking for each skill. On the other hand, in this exemplary embodiment, the output unit 30 outputs the numerical threshold values in association with the proficiency level of the skill. Thus, the learner can grasp what level of skill proficiency is required to answer the question and what level of proficiency his or her own skills have reached.

The following is an overview of the invention. FIG. 12 is a block diagram showing an overview of the skill output device according to the present invention. The skill output device 80 (e.g., skill output device 100) according to the present invention includes an output means 81 (e.g., output unit 30) which outputs a threshold value indicating a proficiency level of a skill required to answer a target question in association with the proficiency level of the skill that the learner is assumed to have.

Such a structure can represent the satisfaction state of the learner's skills required to answer questions.

The output means 81 may output the threshold values for each of a plurality of skills required to answer the target question in association with each of the proficiency level of the plurality of skills that the learner is assumed to have.

The output means 81 may output the proficiency level of the skill that the learner is assumed to have, together with an uncertainty of the proficiency level.

The output means 81 may identify the skill for which the proficiency level does not satisfy the threshold and output a candidate question requiring the identified skill.

In doing so, the output means 81 may output the candidate question requiring the identified skill in an ordered manner according to degree to which the skill is required.

The output means 81 may uses a model representing distribution of a correct answer probability for each question according to the proficiency level of the learner's skill to output the threshold value for each skill calculated by the specified correct answer probability and the proficiency level of the learner's skill relative to the threshold value.

Specifically, the output means 81 may output the threshold value and the proficiency level for each skill using a non-compensatory model.

The output means 81 may use a distribution indicating a state of the learner's skill estimated by Gaussian distribution to output variance of the Gaussian distribution as an uncertainty of the proficiency level.

FIG. 13 is a schematic block diagram showing a configuration of a computer for at least one example embodiment. A computer 1000 includes a processor 1001, a main memory 1002, an auxiliary memory 1003, and an interface 1004.

The above-described skill output device 80 is implemented on the computer 1000. Then, the operation of each of the above-described processing units is stored in the auxiliary storage device 1003 in the form of a program (skill output program). The processor 1001 reads the program from the auxiliary storage device 1003 and develops the program to the main storage device 1002 to execute the above processing according to the program.

In at least one exemplary embodiment, the auxiliary storage device 1003 is an example of a non-transitory tangible medium. The other examples of the non-transitory tangible medium include a magnetic disk, a magneto-optical disk, a CD-ROM (Compact Disc Read-only memory), a DVD-ROM (Read-only memory), and a semiconductor memory connected through the interface 1004. Further, when this program is distributed to the computer 1000 through a communication line, the computer 1000 may develop the distributed program to the main storage device 1002 to execute the above processing.

Further the program may be to implement some of the functions described above. Further, the program may be a so-called differential file (differential program) which implements the above-described functions in combination with another program already stored in the auxiliary storage device 1003.

Some or all of the above exemplary embodiments may also be described as, but not limited to the following.

(Supplementary note 1) A skill output device comprising an output means which outputs a threshold value indicating a proficiency level of a skill required to answer a target question in association with the proficiency level of the skill that the learner is assumed to have.

(Supplementary note 2) The skill output device according to Supplementary note 1 wherein the output means outputs the threshold values for each of a plurality of skills required to answer the target question in association with each of the proficiency level of the plurality of skills that the learner is assumed to have.

(Supplementary note 3) The skill output device according to Supplementary note 1 or 2 wherein the output means outputs the proficiency level of the skill that the learner is assumed to have, together with an uncertainty of the proficiency level.

(Supplementary note 4) The skill output device according to any one of Supplementary notes 1 to 3 wherein the output means identifies the skill for which the proficiency level does not satisfy the threshold and outputs a candidate question requiring the identified skill.

(Supplementary note 5) The skill output device according to Supplementary note 4 wherein the output means outputs the candidate question requiring the identified skill in an ordered manner according to degree to which the skill is required.

(Supplementary note 6) The skill output device according to any one of Supplementary notes 1 to 5 wherein the output means uses a model representing distribution of a correct answer probability for each question according to the proficiency level of the learner's skill to output the threshold value for each skill calculated by the specified correct answer probability and the proficiency level of the learner's skill relative to the threshold value.

(Supplementary note 7) The skill output device according to Supplementary note 6 wherein the output means outputs the threshold value and the proficiency level for each skill using a non-compensatory model.

(Supplementary note 8) The skill output device according to Supplementary note 6 or 7 wherein the output means uses a distribution indicating a state of the learner's skill estimated by Gaussian distribution to output variance of the Gaussian distribution as an uncertainty of the proficiency level.

(Supplementary note 9) A skill output method comprising outputting a threshold value indicating a proficiency level of a skill required to answer a target question in association with the proficiency level of the skill that the learner is assumed to have.

(Supplementary note 10) The skill output method according to Supplementary note 9 wherein outputting the threshold values for each of a plurality of skills required to answer the target question in association with each of the proficiency level of the plurality of skills that the learner is assumed to have.

(Supplementary note 11) A program recording medium in which a skill output program is recorded, the skill output program causing a computer to execute output process of outputting a threshold value indicating a proficiency level of a skill required to answer a target question in association with the proficiency level of the skill that the learner is assumed to have.

(Supplementary note 12) The program recording medium according to Supplementary note 11, wherein the skill output program causing a computer to execute outputting the threshold values for each of a plurality of skills required to answer the target question in association with each of the proficiency level of the plurality of skills that the learner is assumed to have, in the output process.

(Supplementary note 13) A skill output program for causing a computer to execute output process of outputting a threshold value indicating a proficiency level of a skill required to answer a target question in association with the proficiency level of the skill that the learner is assumed to have.

(Supplementary note 14) The skill output program according to Supplementary note 13, wherein the computer is caused to output the threshold values for each of a plurality of skills required to answer the target question in association with each of the proficiency level of the plurality of skills that the learner is assumed to have, in the output process.

Although the invention has been described above with reference to exemplary embodiments and examples, the invention is not limited to the above exemplary embodiments and examples. Various changes can be made in the composition and details of the present invention that can be understood by those skilled in the art within the scope of the present invention.

### REFERENCE SIGNS LIST

10 Storage unit
20 Input unit
30 Output unit
100 Skill output device

What is claimed is:

1. A skill output device comprising:
a memory storing instructions; and
one or more processors configured to execute the instructions to
output a threshold value indicating a proficiency level of a skill required to answer a target question in association with the proficiency level of the skill that the learner is assumed to have.

2. The skill output device according to claim 1 wherein the processor is configured to execute the instructions to
output the threshold values for each of a plurality of skills required to answer the target question in association with each of the proficiency level of the plurality of skills that the learner is assumed to have.

3. The skill output device according to claim 1 wherein the processor is configured to execute the instructions to
output the proficiency level of the skill that the learner is assumed to have, together with an uncertainty of the proficiency level.

4. The skill output device according to claim 1 wherein the processor is configured to execute the instructions to
identify the skill for which the proficiency level does not satisfy the threshold and output a candidate question requiring the identified skill.

5. The skill output device according to claim 4 wherein the processor is configured to execute the instructions to
the output means output the candidate question requiring the identified skill in an ordered manner according to degree to which the skill is required.

6. The skill output device according to claim 1 wherein the processor is configured to execute the instructions to
use a model representing distribution of a correct answer probability for each question according to the proficiency level of the learner's skill to output the threshold value for each skill calculated by the specified correct answer probability and the proficiency level of the learner's skill relative to the threshold value.

7. The skill output device according to claim 6 wherein the processor is configured to execute the instructions to
output the threshold value and the proficiency level for each skill using a non-compensatory model.

8. The skill output device according to claim 6 wherein
use a distribution indicating a state of the learner's skill estimated by Gaussian distribution to output variance of the Gaussian distribution as an uncertainty of the proficiency level.

9. A skill output method comprising
outputting a threshold value indicating a proficiency level of a skill required to answer a target question in association with the proficiency level of the skill that the learner is assumed to have.

10. The skill output method according to claim 9 wherein
outputting the threshold values for each of a plurality of skills required to answer the target question in association with each of the proficiency level of the plurality of skills that the learner is assumed to have.

11. A non-transitory computer readable information recording medium storing a skill output program, when executed by a processor, that performs a method for
outputting a threshold value indicating a proficiency level of a skill required to answer a target question in association with the proficiency level of the skill that the learner is assumed to have.

12. The non-transitory computer readable information recording medium according to claim 11,
outputting the threshold values for each of a plurality of skills required to answer the target question in association with each of the proficiency level of the plurality of skills that the learner is assumed to have.
